(19) United States
(12) Patent Application Publication
(10) Pub. No.: US 2011/0217587 A1
(43) Pub. Date: Sep. 8, 2011

(54) BATTERY PACK HAVING IMPROVED HEAT DISSIPATION AND MOUNTING STRUCTURE AND BATTERY PACK ASSEMBLY INCLUDING THE SAME

(75) Inventors: Jin-Hong An, Yongin-si (KR); No-Hyun Kwag, Yongin-si (KR)

(73) Assignee: SAMSUNG SDI CO., LTD., Yongin-si (KR)

(21) Appl. No.: 12/948,308

(22) Filed: Nov. 17, 2010

(30) Foreign Application Priority Data
Mar. 3, 2010 (KR) 10-2010-0019025

(51) Int. Cl. H01M 10/02

(52) U.S. Cl. 429/156

(57) ABSTRACT

A battery pack and a battery pack assembly including the battery pack. The battery pack includes a holder case to define a plurality of cell spaces, a plurality of battery cells arranged within the plurality of cell spaces, respectively and at least one mounting aperture perforating the holder case and being surrounded by the plurality of cell spaces.

### CLAIM OF PRIORITY

This application makes reference to, incorporates the same herein, and claims all benefits accruing under 35 U.S.C.§119 from an application for BATTERY PACK HAVING IMPROVED HEAT DISSIPATION AND MOUNTING STRUCTURE AND BATTERY PACK ASSEMBLY INCLUDING THE SAME earlier filed in the Korean Intellectual Priority Office on 3 Mar. 2010 and there duly assigned Serial No. 10-2009-0019025.

### BACKGROUND OF THE INVENTION

1. Field of the Invention

One or more embodiments of the present invention relate to a battery pack and a battery pack assembly including the same having a mounting structure and having improved heat dissipation characteristics.

2. Description of the Related Art

As mobile device technology has remarkably developed and the demand for mobile devices has increased, the demand for secondary batteries as an energy source has also rapidly increased. Depending on the types of external devices in which batteries are used, such secondary batteries may be used in the form of a single battery or in the form of a battery pack in which a plurality of batteries are electrically connected and are packed together as one unit.

Small-sized devices such as mobile phones operate with an output and capacity of a single battery for a predetermined amount of time. On the other hand, battery packs are usually used in medium or large size devices such as mobile devices including notebook computers or camcorders, motor-operated bicycles requiring high power, motor scooters, electric motor vehicles, and hybrid electric motor vehicles that need to be driven at a high power for a long period of time. Thus, these medium or large size devices require higher output power and higher capacity batteries. Battery packs are capable of increasing an output voltage and/or an output current according to the number of batteries embedded within the battery packs.

### SUMMARY OF THE INVENTION

One or more embodiments of the present invention include a battery pack and a battery pack assembly having improved mounting structure and heat dissipation.

Additional aspects will be set forth in part in the description which follows and, in part, will be apparent from the description, or may be learned by practice of the presented embodiments.

According to one aspect of the present invention, there is provided a battery pack that includes a holder case to define a plurality of cell spaces, a plurality of battery cells arranged within the plurality of cell spaces, respectively and at least one mounting aperture perforating the holder case and being surrounded by the plurality of cell spaces. The plurality of cell spaces may be arranged in at least one direction on a plane of the holder case, and the at least one mounting aperture may be bounded by at least one of the plurality of cell spaces in the at least one direction. The plurality of cell spaces may be arranged in a first direction and in a second direction that is different from the first direction on a plane of the holder case, and the at least one mounting aperture may be hounded by at least one first cell space in the first direction and at least one second cell space in the second direction. At least one first cell space may be arranged at each of both sides of the at least one mounting aperture in the first direction. At least one second cell space may be arranged at each of both sides of the at least one mounting aperture in the second direction.

The plurality of cell spaces may be arranged in a first direction and in a second direction that is different from the first direction on a plane of the holder case, and the at least one mounting aperture may be arranged on a same extension line as at least one first cell space in the first direction and on a same extension line as at least one second cell space in the second direction. The plurality of cell spaces may be arranged in column and row directions on a plane of the holder case, and the at least one mounting aperture may be arranged between a first column and a column row, excluding the first column and the final column on a row in which the at least one mounting aperture is arranged. The at least one mounting aperture may include at least two mounting apertures spaced apart from each other.

According to another aspect of the present invention, there is provided a battery pack assembly coupled to a support body, the battery pack assembly including a battery pack that accommodates a plurality of battery cells and a mounting frame extending through the battery pack and attached to the support body. The battery pack may include a holder case to define a plurality of cell spaces, the plurality of battery cells accommodated within the plurality of cell spaces, respectively and at least one mounting aperture, each of said at least one mounting aperture perforating the holder case and being surrounded by the plurality of cell spaces. The mounting frame may include at least one coupling member, each of the at least one coupling member extending through a corresponding one of said at least one mounting aperture of the battery pack and being coupled to the support body and a pressing member pressing the battery pack towards the support body, the pressing member extending in a surface direction of the battery pack and attached to each of the at least one coupling members.

The at least one coupling member and the pressing member may be integrally formed. The mounting frame may also include at least one coupler, each of said at least one coupler to couple one of the at least one coupling member to the pressing member. The at least one mounting aperture may include three mounting apertures, and wherein the at least one coupling member comprises three coupling members, each of said coupling members extend through a corresponding one of the three mounting apertures respectively and are coupled to the support body. The plurality of cell spaces may be arranged in at least one direction on a plane of the holder case, and each of said at least one mounting aperture may be adjacent to cell spaces in the at least one direction. The plurality of cell spaces may be arranged in a first direction and in a second direction that is different from the first direction on a plane of the holder case, and each of said at least one mounting aperture may neighbor at least one first cell space in the first direction and at least one second cell space in the second direction. At least one first cell space may be arranged at each of both sides of each of the at least one mounting apertures in the first direction. At least one second cell space may be arranged at each of both sides of each of the at least one mounting apertures in the second direction. The plurality of cell spaces may be arranged in column and row directions on a plane of the holder case, and each of said at least one mounting aperture may be arranged between a first and a last column, excluding the first and the last column of a row in which the at least one mounting aperture is arranged.

### BRIEF DESCRIPTION OF THE DRAWINGS

These and/or other aspects will become apparent and more readily appreciated from the following description of the embodiments, taken in conjunction with the accompanying drawings of which:

FIG. 1 is an exploded perspective view of a battery pack according to an embodiment of the present invention;

FIG. 2 is a perspective view of a holder case of the battery pack of FIG. 1;

FIG. 3 is an enlarged perspective view of main portions of the holder case of FIG. 2;

FIG. 4 is a perspective view of an assembled battery pack according to an embodiment of the present invention;

FIG. 5 is a perspective view of a mounting structure of the battery pack of FIG. 1, according to an embodiment of the present invention;

FIG. 6 is a perspective view of a mounting structure of the battery pack of FIG. 1, according to another embodiment of the present invention;

FIG. 7 is a side view of the mounting structure of FIG. 6, according to an embodiment of the present invention;

FIG. 8 is a perspective view of a mounting structure of the battery pack of FIG. 1, according to another embodiment of the present invention;

FIG. 9 is a schematic view of an electric motor bicycle in which the battery pack of FIG. 1 is mounted, according to an embodiment of the present invention; and

FIG. 10 is a schematic view of an arrangement of battery cells included in the battery pack of FIG. 1, according to an embodiment of the present invention.

### DETAILED DESCRIPTION OF THE INVENTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present invention.

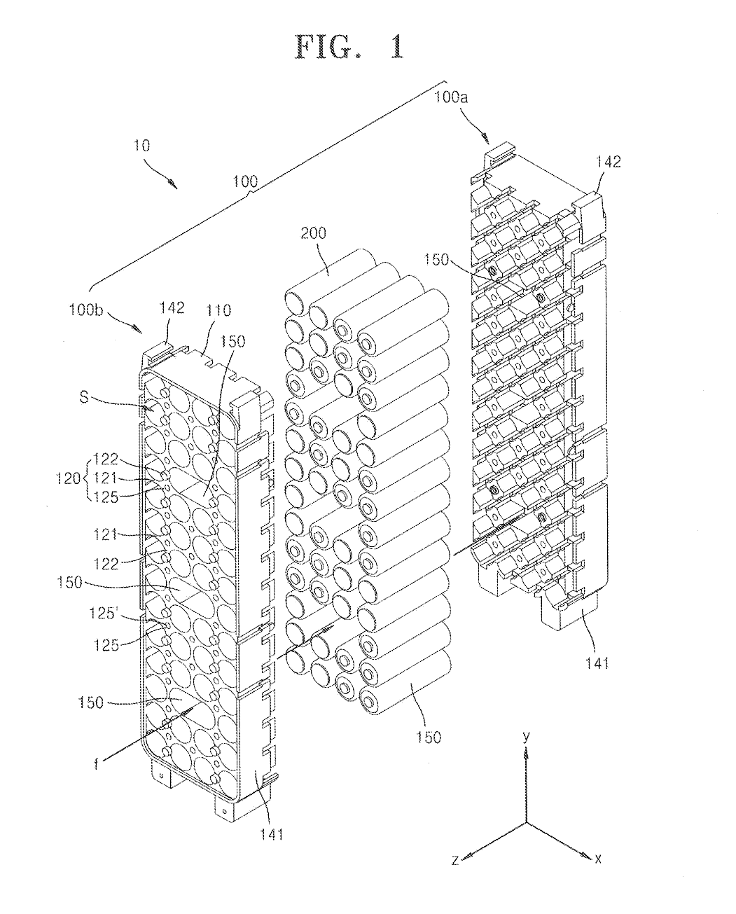

Turning now to FIG. 1, FIG. 1 is an exploded perspective view of a battery pack 10 according to an embodiment of the present invention. Referring to FIG. 1, the battery pack 10 includes a holder case arrangement 100 that includes pair of holder cases 100a and 100b that face each other and a plurality of battery cells 200 that are accommodated in the holder case arrangement 100. The holder case arrangement 100 accommodates the battery cells 200 therein and packs the battery cells 200 as one unit. The battery cells 200 are accommodated in the holder case arrangement 100.

The holder case arrangement 100 may include a first holder case 100a and a second holder case 100b that face each other. A plurality of cell spaces S are formed between the first holder case 100a and the second holder case 100b of the holder case arrangement 100. The battery cells 200 may be accommodated in the cell spaces S formed in the holder case arrangement 100.

A plurality of mounting apertures 150 are formed in the holder case arrangement 100 to pass through to the outer surface of the second holder case 100b from the outer surface of the first holder case 100a. The outer surface of the first holder case 100a is referred to as a surface that is opposite to the second holder case 100b. The outer surface of the second holder case 100b is referred to as a surface that is opposite to the first holder case 100a.

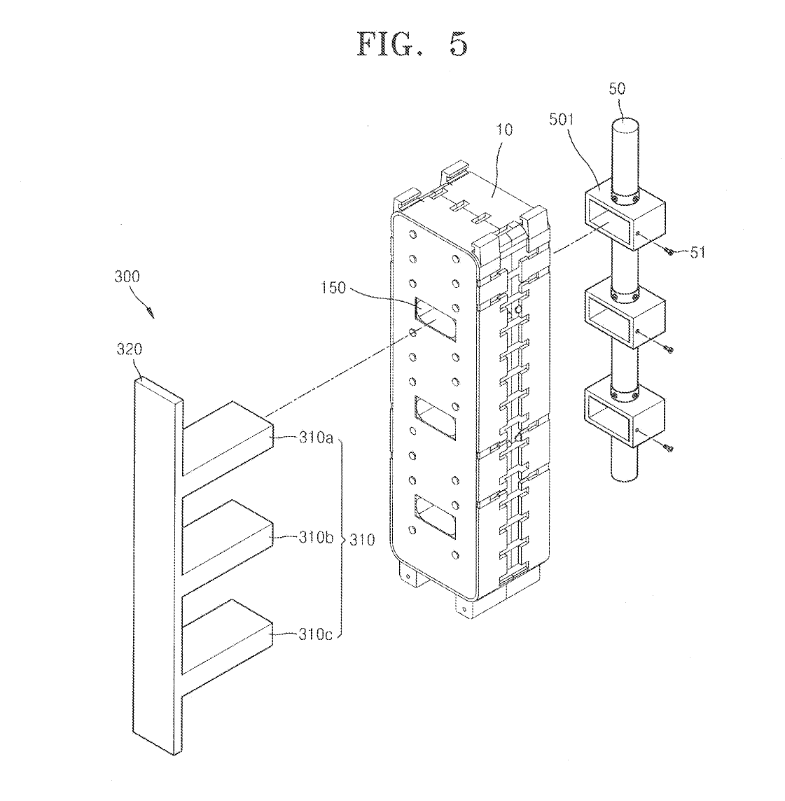

The mounting apertures 150 may be used to fix the battery pack 10 to an apparatus that the battery pack 10 will power. For example, the battery pack 10 may be mounted onto a motor assisted bicycle and may be mounted with respect to a bicycle (not shown). In this regard, the battery pack 10 is supported on a mounting frame (not shown) that is locked into a bicycle through the mounting apertures 150. The mounting frame includes a plurality of coupling members, each of which extend through a corresponding one of the mounting apertures 150 and a pressing member extending along one surface of the holder case arrangement 100, attached to the plurality of coupling members and serving to tightly fix the battery pack 10 to the bicycle. A structure of mounting the battery pack 10 will be descried in more detail later in conjunction with FIGS. 5 through 8.

Meanwhile, the mounting apertures 150 provide a heat dissipation path for the battery cells 200 accommodated within the cell spaces S. The mounting apertures 150 are surrounded by ones of the cell spaces S and provide a heat dissipation path for the battery cells 200 accommodated within the cell spaces S. An air flow f induced through the mounting apertures 150 may absorb heat produced by battery cells 200 adjacent to the mounting apertures 150 and dissipate the heat to the outside.

For example, the mounting apertures 150 may be formed across the inside the holder case arrangement 100 and are surrounded by the cell spaces S, thereby efficiently dissipating heat generated from the battery cells 200 disposed inside the holder case arrangement 100. For example, the mounting apertures 150 prevent the adjacent battery cells 200 from thermally contacting each other, thereby preventing adjacent battery cells 200 from heating each other (i.e., consecutive heating) in an abnormal operating environment in which the battery cells 200 are overheated.

The cell spaces S may be arranged in at least one direction on a plane (x-y plane) of the holder case 100, for example, in a column direction along the y-axis and in a row direction along the x-axis. The mounting apertures 150 are not wholly formed over an entire column or an entire row. The mounting apertures 150 are partially formed over an entire column or an entire row in the column direction along the y-axis and in the row direction along the x-axis, and each mounting aperture 150 is surrounded by battery cells 200. In other words, the mounting apertures 150 are formed between the battery cells 200 arranged in the column direction along the y-axis and in the row direction along the x-axis. At least one of the battery cells 200 is disposed in both sides of the mounting apertures 150 in the column direction along the y-axis and in the row direction along the x-axis. The number of the battery cells 200 is increased, and thus the battery pack 10 of high capacity and high output can be formed. The battery cells 200 adjacent to the mounting apertures 150 can have increased heat dissipation efficiency due to the proximity of the mounting apertures 150 and the increased air flow and cooling effect created by the mounting apertures.

The mounting apertures 150 provide heat dissipation paths for the battery cells 200 while allowing the battery pack 10 to be mounted on another object, and thus an additional mounting device for mounting the battery pack 10 and a space for installing the mounting device are unnecessary. The battery pack 10 can be compact in terms of the spatial efficiency, which may be favorable to, for example, an application where space is limited, such as a bicycle where the battery pack 10 is used to smoothly operate pedals of a bicycle.

The shape of the first and second holder cases 100a and 100b may be symmetrical. The first holder case 100a may be combined with the second holder case 100b in a z-direction, in such a manner that the battery cells 200 are accommodated inside the holder case arrangement 100. Throughout the present specification, an inner surface of the holder case arrangement 100 is referred to as a surface that the first holder case 100a and the second holder case 100b both face, and an outer surface of the holder case arrangement 100 is referred to as a surface that is opposite to the surface that the first holder case 100a and the second holder case 100b face. The portions of the first and second holder cases 100a and 100b, which accommodate the battery cells 200, may be symmetrical to each other, but combination portions of the first and second holder cases 100a and 100b may also have complementary members, so that they may be engaged with one another.

Each of the first and second holder cases 100a and 100b may include a holder frame 110 that forms an outline of each of the holder cases 100a and 100b, respectively, and a plurality of ribs 120 that are integrally formed with the holder frames 110 and separate the battery cells 200 from one another. The ribs 120 define the cell spaces S in which each of the battery cells 200 are accommodated so that the battery cells 200 embedded within the battery pack 10 may be arranged in a plurality of columns and rows at regular intervals. Each cell space S may have the form of an aperture that is disposed inside the holder case arrangement 100. For example, the ribs 120 may provide cylindrical support surfaces so as to encompass the circumferences of cylindrical type battery cells 200. Each of the ribs 120 may include a first fin 121 that extends in the row direction along the x-axis and a second fin 122 that extends in the column direction along the y-axis in order to separate the battery cells 200 arranged in the column direction along the y-axis and the row direction along the x-axis respectively, and a column 125 that is disposed at a location where the first fin 121 and the second fin 122 cross each other.

A heat dissipation aperture 125′ for forming an air path is formed along the extension direction (i.e., z-direction) of each column 125 in each of the ribs 120. For example, each heat dissipation aperture 125′ has a circular cross-sectional shape and perforates each column 125 throughout its overall length. The air flow f in the heat dissipation aperture 125′ proceeds into spaces between the neighboring battery cells 200, and heat generated during a charge and/or discharge operation is absorbed and dissipated by the air flow f within the heat dissipation aperture 125′. The air flow f induced within the heat dissipation aperture 125′ may be generated naturally or may be initiated by an external movement of air so that heat dissipation can be performed by natural or forced convection respectively. For example, a cooling fan (not shown) that provides cooling air to the heat dissipation aperture 125′ may be disposed outside the holder case arrangement 100.

The first fin 121 extends in the row direction along the x-axis so that neighboring columns 125 arranged in the row direction along the x-axis may be connected to each other. The second fin 122 extends in the column direction along the y-axis so that neighboring columns 125 arranged in the column direction along the y-axis may be connected to each other. Accordingly, the neighboring columns 125 are supported via the first and second fins 121 and 122.

As the columns 125 are connected to each other via the first and second fins 121 and 122, the cylindrical cell space S that supports the circumference of each of the battery cells 200 may be defined. Accordingly, contact between neighboring battery cells 200 may be prevented. Further, consecutive heating of the neighboring battery cells 200 may be prevented, even in an abnormal operating environment where certain battery cells 200 are overheated. For example, the holder case arrangement 100 may be formed as a single body and may be formed of plastic having an excellent processing property and excellent insulation characteristics.

The columns 125 are connected to one another via the first and second fins 121 and 122 and thus ensure structural rigidity of the holder case arrangement 100. Further, the columns 125 are separated from each other by the first and second fins 121 and 122 inside the surface of the holder case arrangement 100 so that a portion of the surface of the battery cells 200 can be directly exposed to the low temperature air.

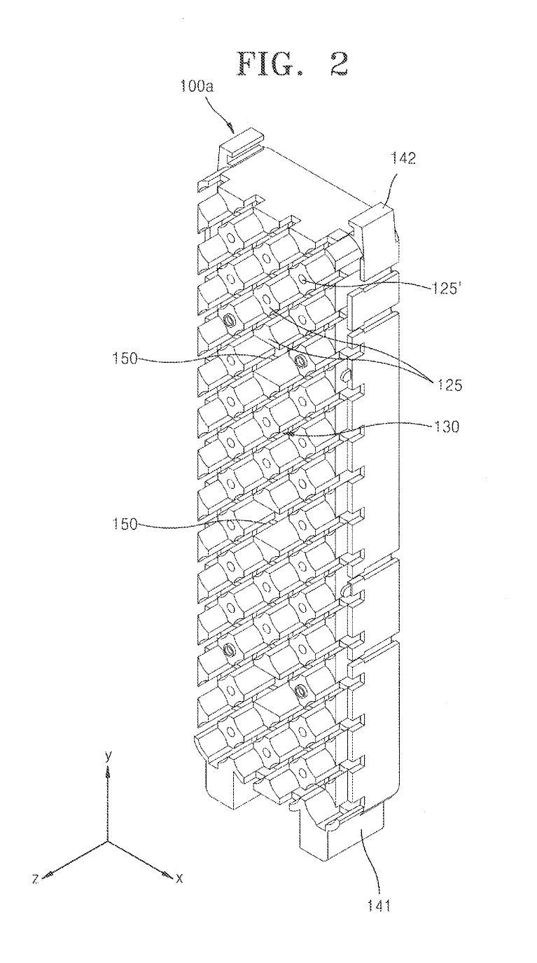

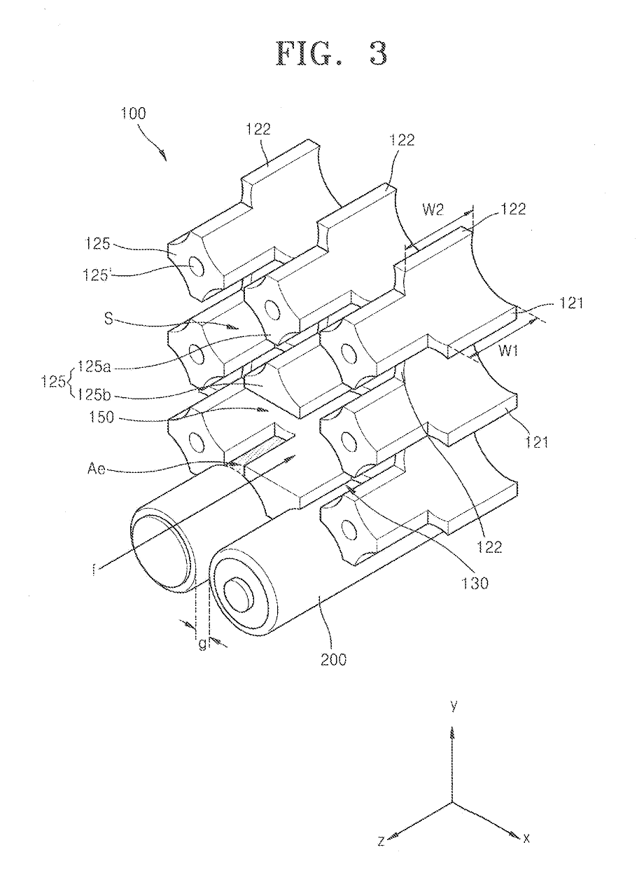

Turning now to FIGS. 2 and 3, FIG. 2 is a perspective view of first holder case 100a of the battery pack 10 of FIG. 1 and FIG. 3 is an enlarged perspective view of main portions of the first holder case 100a of FIG. 2. Since first and second holder cases 100a and 100b are symmetrical, it is to be understood that the present description of the first holder case 100a also applies to the second holder case 100b. Referring to FIGS. 2 and 3, the columns 125 are arranged in the row direction along the x-axis and in the column direction along the y-axis. A gap 130, through which the surface of the battery cells 200 is exposed, is formed between the columns 125. The gap 130 may be formed between portions of the columns 125 on which the first and second fins 121 and 122 are not formed (refer to FIG. 3). These portions of the columns 125 are separated from one another by the gap 130 formed therebetween, and thus adjacent columns are isolated from each other.

A surface Ae of the battery cells 200 is exposed through the gap 130 and is directly exposed to the low temperature air. Accordingly, heat may dissipate by convection, and heat accumulation of the battery cells 200 during a charge and/or discharge operation may be prevented. The first and second fins 121 and 122 may extend in a direction along the z-axis to surround an end of the column 125, thus supporting the circumference of the battery cells 200. The first and second fins 121 and 122 extend in the direction along the z-axis into the inside of the first holder case 100a by widths w1 and w2.

The widths w1 and w2 of the first and second fins 121 and 122 determine the size of the exposed area of the battery cells 200. In other words, as the widths w1 and w2 of the first and second fins 121 and 122 are increased, more surface area of the battery cells 200 is covered by the first and second fins 121 and 122, and thus the exposed surface Ae of the battery cells 200 is decreased. On the contrary, if the widths w1 and w2 of the first and second fins 121 and 122 are decreased, the gap 130 is increased due to the decreased widths w1 and w2 of the first and second fins 121 and 122, resulting in an increase in the exposed surface Ae of the battery cells 200. By adjusting the widths w1 and w2 of the first and second fins 121 and 122, the exposed surface Ae of the battery cells 200 may be changed. As the exposed surface Ae of the battery cells 200 is increased, heat dissipation may be expedited. However, when the exposed surface Ae of the battery cells 200 is increased to an excess, thermal contact between the neighboring battery cells 200 may occur, and the neighboring battery cells 200 may be consecutively heated and deteriorate in an abnormal operating environment in which the certain battery cells 200 are overheated. Thus, the exposed surface Ae of the battery cells 200 may be designed to an appropriate size.

A separation gap g between the battery cells 200 that are arranged in designated positions at regular intervals may be obtained. When the separation gap g is defined as the shortest distance from a curvature point to another curvature point between two neighboring battery cells 200, the separation gap g of at least 2 mm or more may be formed in view of heat dissipation efficiency. The minimum separation gap g is formed in this way so that thermal contact between the neighboring battery cells 200 may be prevented, consecutive deterioration may be prevented, and sufficient air flow in the separation gap g may be achieved so that heat dissipation may be expedited.

The heat dissipation apertures 125′ that form the air path f are formed along the extension direction of the columns 125. Four battery cells 200 are symmetrically disposed around each heat dissipation aperture 125′, and heat generated by each battery cell 200 arranged about a heat dissipation aperture 125′ is dissipated by the air flow f within the heat dissipation aperture 125′. Each cell space S, in which each battery cell 200 is accommodated, is defined by the four neighboring columns 125 in the row direction along the x-axis and in the column direction along the y-axis. For example, the lateral surface of the column 125 may be formed so as to encompass the cylindrical battery cells 200.

The mounting apertures 150 for mounting the holder case arrangement 100 to an external apparatus are formed in the holder case arrangement 100. The mounting apertures 150 may be formed in an internal region of the holder case arrangement 100 in such a way that the mounting apertures 150 are surrounded by the cell spaces S, and may be defined by the columns 125. For example, referring to FIG. 3, the columns 125 may include first columns 125a that partition the cell spaces S in which the battery cells 200 are accommodated and second columns 125b that partition the mounting apertures 150 and the cell spaces as well. The first and second columns 125a and 125b may have different shapes. For example, the second columns 125b define the cell spaces S by upper side surfaces, and the mounting apertures 150 by lower side surfaces.

The mounting apertures 150 are not formed over an entire row or an entire column and are instead partially formed over a row or a column of the cell spaces S arranged in a column direction along the y-axis or in a row direction in the x-axis. At least one of the cell spaces S may be formed at both sides of the mounting apertures 150 in the column direction along the y-axis and in the row direction along the x-axis. Because battery cells 200 surround the mounting apertures and because the mounting apertures allow for a flow of air, heat generated from the battery cells 200 accommodated in the cell spaces S near the mounting apertures 150 may be effectively dissipated.

According to an embodiment of the present invention, the sizes of the mounting apertures 150 may occupy two of the four cells spaces S arranged in a row direction along the x-axis of the holder case arrangement 100. In this scenario, one cell space S is arranged on the same row as the mounting aperture and to the left of the mounting aperture, and one cell space is arranged in the same row as the mounting aperture but to the right of the mounting aperture 150. The size of the mounting apertures 150 may correspond to that of one cell space S in a column direction along the y-axis. The cell spaces S neighbor the mounting apertures 150 on both an up and down side of the mounting apertures in the column direction along the y-axis.

Because cell spaces S surround each mounting aperture 150 and are thus arranged adjacent to the mounting apertures 150, improved the heat dissipation efficiency of the battery cells 200, especially for those battery cells 200 adjacent to the mounting apertures 150, can be realized. This is because the cell spaces S in which the battery cells 200 are accommodated and arranged adjacent to the mounting apertures 150 can experience improved heat dissipation due to the flow of air f through the mounting apertures 150, which is effective in terms of heat dissipation. The air flow f induced through the mounting apertures 150 may absorb heat from the battery cells 200 adjacent to the mounting apertures 150 and dissipate this heat to the outside. The air flow f induced in the mounting apertures 150 may be generated naturally according to a distribution of temperatures or may be generated by a cooling fan (not shown) that forces the air flow f.

It is more effective to form the mounting apertures 150 at an inner region of the holder case arrangement 100 than at a boundary of the holder case arrangement 100 in terms of a temperature balance between the battery cells 200. In more detail, heat generated by the battery cells 200 that are disposed at the inner region of the holder case arrangement 100 and thermally contacting neighboring battery cells 200 can be efficiently dissipated due to the mounting apertures 150 rather than the battery cells 200 disposed at the boundary of the holder case 100 arrangement, thereby equalizing the temperature distribution of the battery cells 200 and preventing the battery cells 200 disposed at the inner region of the holder case arrangement 100 from being overheated.

Each battery cell 200 to be accommodated in the holder case arrangement 100 may be a secondary battery that may be charged and/or discharged, such as a lithium ion secondary battery having excellent output and capacity. Various types of batteries, such as a nickel-cadmium secondary battery, a nickel-hydrogen secondary battery, a lithium battery, etc. may be used. The battery cells 200 are charged or discharged with a large amount of current of 1000 mA or more, for example, 1800 mA.

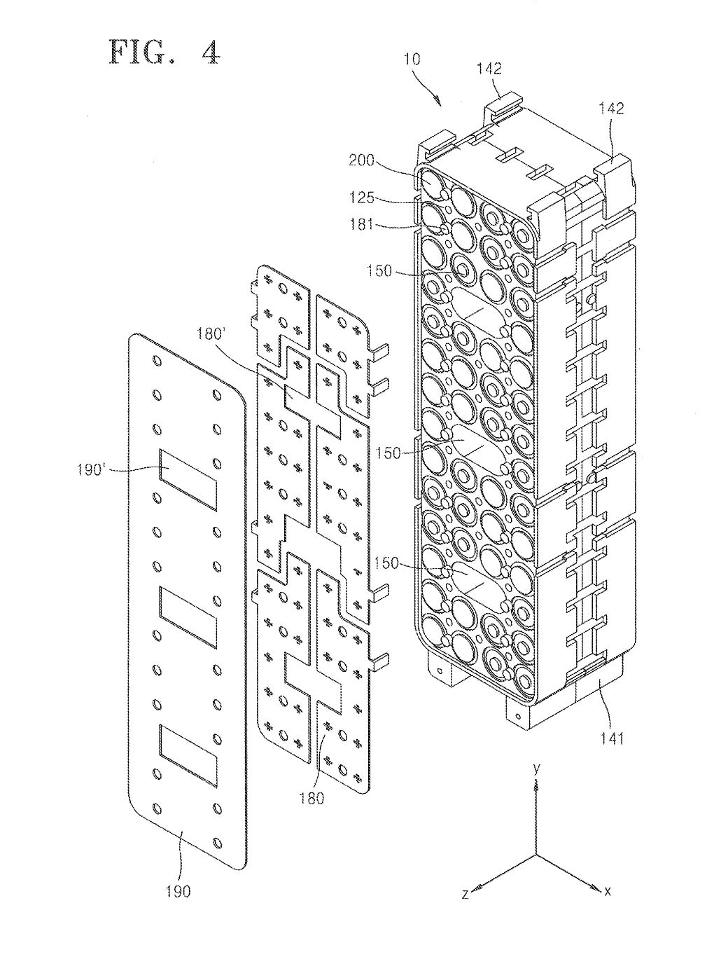

Turning now to FIG. 4, FIG. 4 is a perspective view of an assembled battery pack according to an embodiment of the present invention. Referring to FIG. 4, the first and second holder cases 100a and 100b are assembled to face each other to form the holder case arrangement 100 while the battery cells 200 are disposed therein. In this arrangement, the battery cells 200 are disposed at positions of the cell spaces S defined by the holder case arrangement 100 and at regular intervals.

A lead plate 180 is disposed on a front or back surface of the holder case arrangement 100 and electrically connects the battery cells 200 embedded within the battery pack in series and/or in parallel. The lead plate 180 may be coupled to an assembly protrusion 181 that protrudes from the holder case arrangement 100. The assembly protrusion 181 may serve as a stopper that prevents the battery cells 200 accommodated within the holder case arrangement 100 from sliding out of the holder case arrangement 100.

The lead plate 180 connects electrodes of the battery cells 200 in series and/or in parallel. The connection structure of the battery cells 200 connected in series and in parallel or the number it and arrangement of the battery cells 200 that constitute parallel blocks may be changed in various configurations. Also, the type of arrangement of the battery cells 200 that constitute the battery pack 10 is not limited to that described above.

A plurality of openings 180′ for mounting the battery pack 10 onto an external apparatus may be disposed at positions on the lead plate 180 that correspond to the mounting apertures 150 of the holder case arrangement 100. For example, the openings 180′ may be formed as gaps spaced between divided lead plates 180 or as a through hole formed in the lead plate 180.

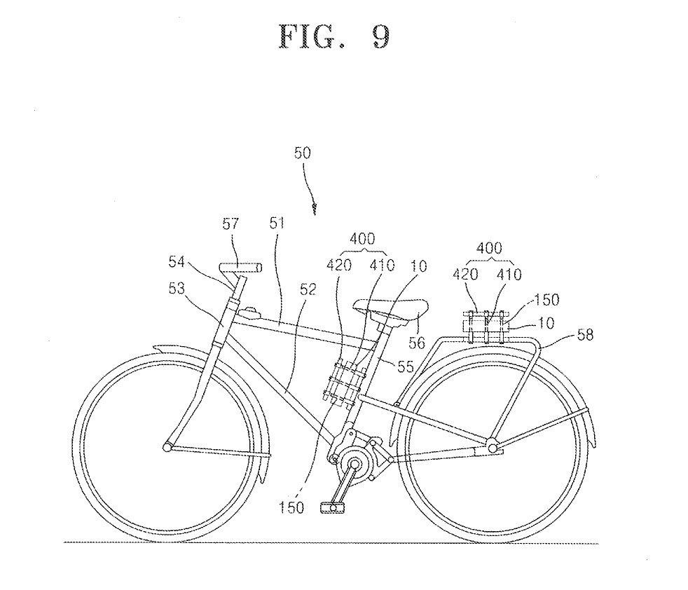

An insulating cover 190 is assembled to an outside of the lead plate 180 so that the battery cells 200 accommodated within the holder case arrangement 100 may be protected and so that the lead plate 180 may be electrically insulated from an external environment. A plurality of through apertures 190′ are formed in insulating cover 190 at positions corresponding to the mounting apertures 150 of holder case arrangement 100. The through apertures 190′, openings 180′ and the mounting apertures 150 form a space through which coupling members of a mounting frame (see FIGS. 5 through 8) can perforate. One end of the mounting frame that is inserted into the battery pack 10 through the through apertures 190′, openings 180′ and the mounting apertures 150 is coupled to an external apparatus, such as a bicycle (see FIG. 9), so that the battery pack 10 may be mounted on the bicycle.

According to another embodiment of the present invention, an insulating tape (not shown) instead of an insulating cover 190 is attached to an outside of the lead plate 180 so that the lead plate 180 may be electrically insulated from an external environment, and a cover member (not shown) may be assembled to the holder case arrangement 100 to which the insulating tape is attached.

The battery pack 10 may include a circuit board (not shown) that detects the state of voltage of the battery cells 200 and controls a charge and/or discharge operation. The circuit board is electrically connected to the lead plate 180 that constitutes a current path, and may be connected to the lead plate 180 via a lead line (not shown) drawn out from the circuit board. The circuit board detects the state of voltage of each battery cell 200 and provides a charge current via the lead plate 180.

Meanwhile, leg members 141 and 142 that support the battery pack 10 in an upright position may be disposed at upper and lower ends of the holder case arrangement 100. For example, the leg members 141 and 142 may be disposed at the right and left sides of the holder case arrangement 100, and the battery pack 10 may be maintained in a stable upright position by the leg members 141 and 142 disposed in four symmetrical corners of the holder case arrangement 100.

Turning now to FIG. 5, FIG. 5 is a perspective view of a mounting structure of the battery pack 10 according to an embodiment of the present invention. Referring to FIG. 5, the battery pack 10 in which the battery cells 200 are accommodated is mounted onto a bicycle frame 50. The battery pack 10 may be mounted on a motor-operated bicycle to wholly or partially assist a driving force of an electric motor bicycle, and may be attached to and detached from the bicycle frame 50 in order to charge the battery cells 200.

The battery pack 10 may be fixed to the bicycle frame 50 using a mounting frame 300. The mounting frame 300 includes a plurality of coupling members 310 that are locked into the bicycle frame 50 and extend through the mounting apertures 150 of the battery pack 10. The mounting frame 300 further includes a pressing member 320 that extends in one surface direction of the battery pack 10 connecting the coupling members 310 and allowing the battery pack 10 to be tightly adhered to the bicycle frame 50. As an embodiment of the present invention, the coupling members 310 may include first through third coupling members 310a, 310b, and 310c that are respectively inserted into the mounting apertures 150 formed at different positions in the battery pack 10, and the pressing member 320 extends along one surface of the battery pack 10 and is attached to the first through third coupling members 310a, 310b, and 310c. The pressing member applies pressure to the battery pack 10 in a direction of the bicycle frame 50, and firmly secures the battery pack 10 in place.

The coupling members 310 may include the first through third coupling members 310a, 310b, and 310c that extend side by side in a direction of thickness of the battery pack 10. The first through third coupling members 310a, 310b, and 310c may be coupled to the bicycle frame 50 and extend through the mounting apertures 150 of the battery pack 10 and are spaced apart from each other by a predetermined gap. The shapes of the coupling members 310 may correspond to those of the mounting apertures 150. For example, in the present embodiment of FIG. 5, the coupling members 310 may have square pillar shapes. The coupling members 310 inserted into the mounting apertures 150 may be inserted into a plurality of brackets 501 arranged on the bicycle frame 50, and may be fixed to the bicycle frame 50 through a plurality of screw members 51 that are locked into the brackets 501. The coupling members 310 and the pressing members 320 included in the mounting frame 300 may be integrally formed.

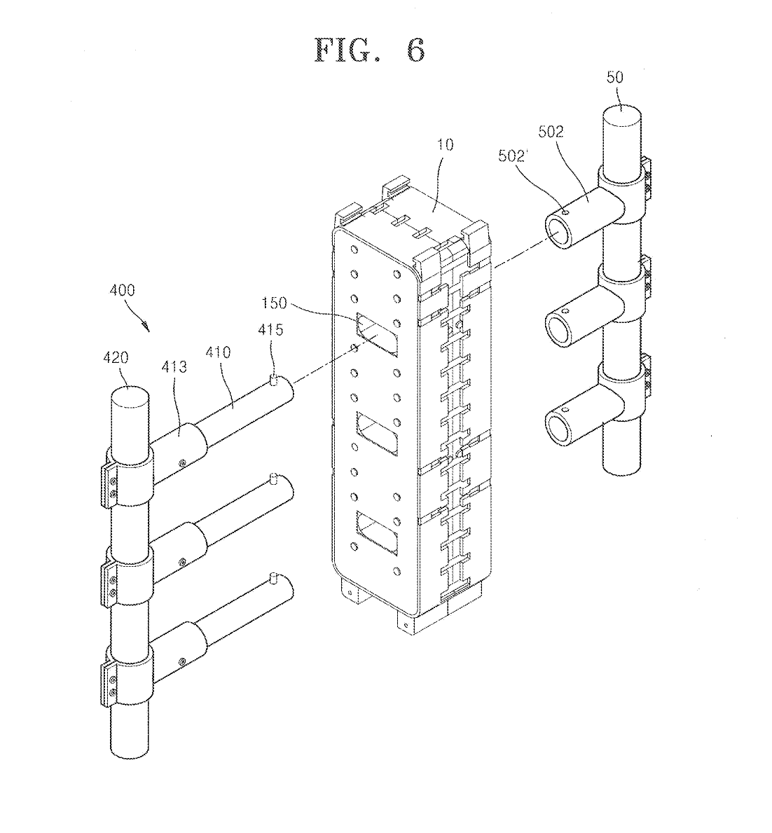

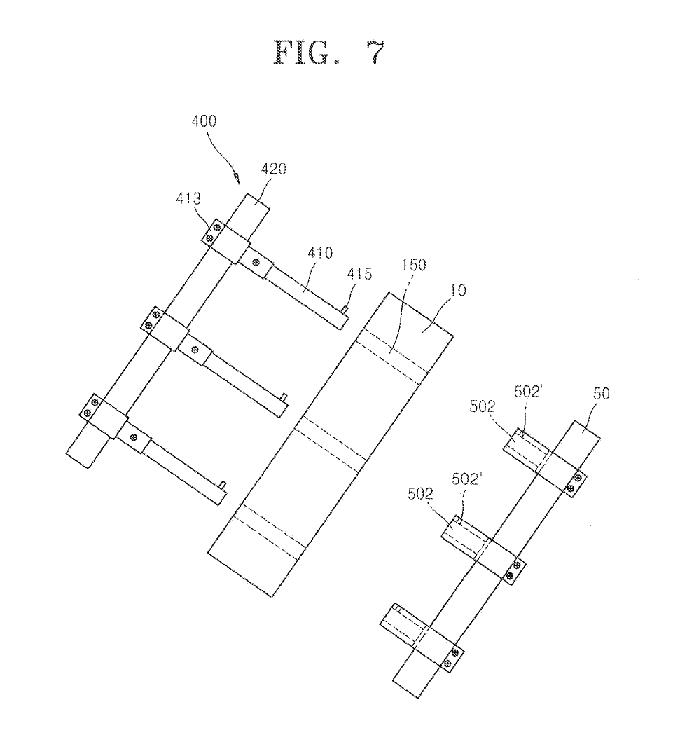

Turning now to FIGS. 6 and 7, FIGS. 6 and 7 are views of a mounting frame 400 according to another embodiment of the present invention. Referring to FIGS. 6 and 7, a plurality of coupling members 410 and a pressing member 420 included in the mounting frame 400 are not formed integral but are separate members and are coupled to each other using a predetermined coupling means in order to form the mounting frame 400. For example, the coupling members 410 and the pressing member 420 may be coupled with each other by inserting one end of the coupling member 410 into a bracket 413 that is assembled to surround the pressing member 420 in order to form the mounting frame 400. The coupling members 410 and the pressing member 420 may be formed as a rod member having a circular cross section.

The coupling members 410 may be assembled on the bicycle frame 50 through a predetermined locking apparatus. In this regard, the locking apparatus used to couple the coupling members 410 to the bicycle frame 50 may be repeatedly locked and unlocked using a mechanical coupling technique. Thus, the battery pack 10 may be attached to and detached from the bicycle frame 50 and may be easily separated from the bicycle frame 50 in order to charge the battery pack 10.

In the present embodiment described with reference to FIGS. 6 and 7, the locking apparatus may include an engaging projection 415 disposed at the end of each coupling member 410 that engages with corresponding engaged portions which are coupling apertures 502′ arranged on a corresponding bracket 502 of bicycle frame 50 into which the engaging projections 415 are inserted. The engaging projections 415 may be elastically biased by an elastic body and project toward the outside, and the plurality of brackets 502 formed may have a hollow circular shape in order to accommodate one end of each of the coupling members 410. Each bracket 502 includes one coupling aperture 502′ formed at appropriate locations along the circumference of the bracket 502 and used to allow for insertion of the engaging projections 415 thereinto in order to prevent the coupling members 410 from being separated from the brackets 502.

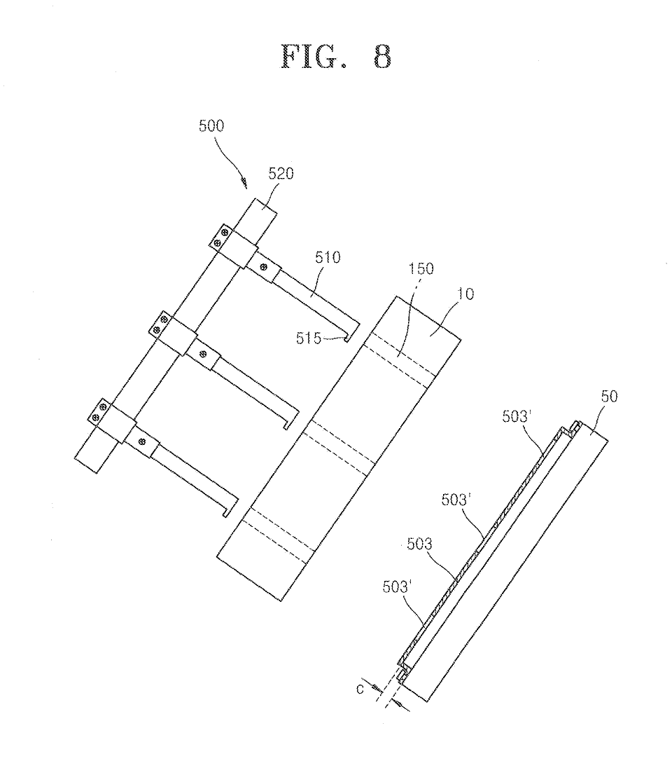

Turning now to FIG. 8, FIG. 8 is a perspective view of another locking apparatus for coupling a plurality of coupling members 510 to a bicycle frame 50 according to another embodiment of the present invention. Referring to FIG. 8, the locking apparatus may include a plurality of hook members 515, one of said hook members 515 being arranged at one end of each of the coupling members 510. The locking apparatus of FIG. 8 further includes a plurality of engaged portions formed in the bicycle frame 50 into which the hook members 515 are firmly inserted. The hook members 515 may be bent to have a hook shape on one end of each of the coupling members 510. For example, the engaged portions may be apertures 503′ formed in a frame 503 that is fixed to the bicycle frame 50 at a predetermined recess c. The hook members 515 may be hooked into the apertures 503′ through the recess c. A mounting frame 500 includes the coupling members 510 inserted into the mounting apertures 150 of the battery pack 10 and a pressing member 520 attached to each of the coupling members 510.

Turning now to FIG. 9, FIG. 9 is a schematic view of the bicycle frame 50 on which the battery pack 10 is mounted according to an embodiment of the present invention. Referring to FIG. 9, a head pipe 53 is disposed in the front of the bicycle frame 50. A steering axis 54 is rotatably inserted into the head pipe 53. A handle 57 is installed at an upper portion of the steering axis 54. An upper frame 51 and a lower frame 52 extend from the rear of the head pipe 53. The upper frame 51 extend almost horizontally from the head pipe 53. The lower frame 52 may extend at a downward incline from the head pipe 53. The upper frame 51 and the lower frame 52 form a main frame closed by a seat frame 55 formed at the rear thereof. A seat 56 may be mounted at an upper end of the seat frame 55.

For example, the battery pack 10, in which the battery cells 200 are accommodated, may be mounted onto the seat frame 55. The battery pack 10 may be fixed onto the seat frame 55 via the mounting frame 400 of FIGS. 6 and 7. The mounting frame 400 may include a coupling member 410 coupled to the seat frame 55 and extending through the battery pack 10. The mounting frame 400 also includes a pressing member 420 extending at one side of the battery pack 10 and coupled to each of the coupling members 410 and pressing the one side of the battery pack 10 toward the seat frame 55. A position where the battery pack 10 is coupled to the bicycle frame 50 is not limited thereto as the battery pack 10 may instead be installed at various other positions, and may be mounted on any portion of the bicycle frame 50. For example, the battery pack 10 may be installed at an appropriate position along the upper frame 51 or the lower frame 52 or may instead be installed on a carrier member 58.

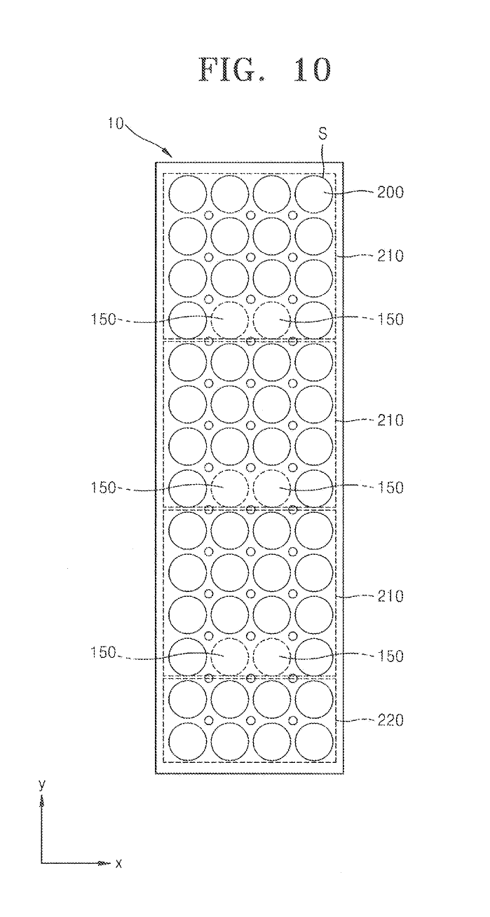

Turning now to FIG. 10, FIG. 10 is a schematic view of an arrangement of the battery cells 200 included in the battery pack 10 of FIG. 1 according to an embodiment of the present invention. Referring to FIG. 10, a 10S5P battery pack 10 is formed by connecting ten battery cells 200 in series and connecting five groups of ten battery cells 200 in parallel.

The mounting apertures 150 are formed at an inner region of the battery pack 10 and are surrounded by cell spaces S, thereby achieving an air flow between the battery cells 200 accommodated in the cell spaces S. Therefore, the air flow induced through the mounting apertures 150 may absorb and remove heat generated by the battery cells 200 and dissipate the heat to the outside.

The cell spaces S may be arranged in a first direction, for example, in the y-axis direction, inside the holder case arrangement 100. The cell spaces S may also be arranged in a second direction, for example, in the x-axis direction perpendicular to the first direction. That is, the cell spaces S may be arranged in a column direction along the y-axis and in a row direction along the x-axis.

The battery pack 10 may further include a plurality of first groups 210 of cell spaces S and a second group 220 of cell spaces S in which the battery cells 200 are arranged in columns and rows. Each of the first groups 210 may include cell spaces S arranged in N columns along the y-axis direction and in N rows along the x-axis direction.

The second group 220 may include the cell spaces S arranged in N columns along the y-axis direction and in M rows along the x-axis direction, where M and N are natural numbers. In this case, the battery cells 200 may occupy all the cell spaces S of the second group 220.

The cell spaces S of at least one of the first groups 210 may be arranged in the y-axis direction. Further, the cell spaces S of the second group 220 may be consecutively arranged in the y-axis direction from the last first group 210 of the first groups 210 that are arranged in the y-axis direction.

For example, the mounting apertures 150 may be formed between a 1st column and an Nth column of a 1st row, excluding the 1st column and the Nth column of the 1st row. The mounting apertures 150 may be wholly or partially formed between the 1st column and the Nth column of the 1st row in the first groups 210, excluding the 1st column and an Nth column of the 1st row.

M may be 2 and N may be 4 in the 10S5P battery pack 10. In this case, the first groups 210 may include the 4×4 cell spaces S of which two cell spaces in the 1st row of each first group 210 may be occupied by mounting apertures 150. This results in 14 cell spaces S in each first group 210 that can be occupied by a battery cell. If there are three first groups 210 and a single second group 220 of 8 cell spaces S, the total number of cells that can be accommodated in battery pack 200 is (3×14)+8=50 which allows for the 10S5P arrangement of 5 parallel batteries, each containing 10 battery cells 200 in series.

According to an embodiment, the mounting apertures 150 are formed to have a width that occupies two cell spaces S and have different shapes from the cell spaces S. In another embodiment of the present invention, although the mounting apertures 150 may have the same shape as the cell spaces S, since the mounting apertures 150 are perforated by mounting frame 400, the battery cells 200 are not accommodated in the mounting apertures 150. For example, the mounting apertures 150 may be formed in a 2nd or 3rd column of a 1st row of a first group 210, and the mounting apertures 150 may have similar shapes to or the same shapes as the cell spaces S.

According to the present invention, a battery pack and a battery pack assembly including the battery pack provides an improved mounting structure in which the battery pack and the battery pack assembly can be easily mounted onto a support body, such as an electric motor bicycle. The battery pack and the battery pack assembly can further provide a heat dissipation structure in which heat generated by a plurality of battery cells accommodated within the battery pack may be efficiently dissipated.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A battery pack, comprising:
a holder case to define a plurality of cell spaces;
a plurality of battery cells arranged within the plurality of cell spaces, respectively; and
at least one mounting aperture perforating the holder case and being surrounded by the plurality of cell spaces.

2. The battery pack of claim 1, wherein the plurality of cell spaces are arranged in at least one direction on a plane of the holder case, and the at least one mounting aperture being adjacent to at least one of the plurality of cell spaces in the at least one direction.

3. The battery pack of claim 1, wherein the plurality of cell spaces are arranged in a first direction and in a second direction that is different from the first direction on a plane of the holder case, and the at least one mounting aperture being adjacent to at least one first cell space in the first direction and at least one second cell space in the second direction.

4. The battery pack of claim 3, wherein at least one first cell space is arranged at each of both sides of the at least one mounting aperture in the first direction.

5. The battery pack of claim 3, wherein at least one second cell space is arranged at each of both sides of the at least one mounting aperture in the second direction.

6. The battery pack of claim 1, wherein the plurality of cell spaces are arranged in a first direction and in a second direction that is different from the first direction on a plane of the holder case, and the at least one mounting aperture is arranged on a same extension line as at least one first cell space in the first direction and on a same extension line as at least one second cell space in the second direction.

7. The battery pack of claim 1, wherein the plurality of cell spaces are arranged in column and row directions on a plane of the holder case, and the at least one mounting aperture is arranged between a first column and a last column, excluding the first column and the last column on a row in which the at least one mounting aperture is arranged.

8. The battery pack of claim 1, wherein the at least one mounting aperture comprises at least two mounting apertures spaced apart from each other.

9. A battery pack assembly coupled to a support body, the battery pack assembly comprising:
a battery pack that accommodates a plurality of battery cells; and
a mounting frame extending through the battery pack and attached to the support body.

10. The battery pack assembly of claim 9, wherein the battery pack comprises:
a holder case to define a plurality of cell spaces;
the plurality of battery cells accommodated within the plurality of cell spaces, respectively; and
at least one mounting aperture, each of said at least one mounting aperture perforating the holder case and being surrounded by the plurality of cell spaces.

11. The battery pack assembly of claim 10, wherein the mounting frame comprises:
at least one coupling member, each of the at least one coupling member extending through a corresponding one of said at least one mounting aperture of the battery pack and being coupled to the support body; and
a pressing member pressing the battery pack towards the support body, the pressing member extending in a surface direction of the battery pack and attached to each of the at least one coupling members.

12. The battery pack assembly of claim 11, wherein the at least one coupling member and the pressing member are integrally formed.

13. The battery pack assembly of claim 11, wherein the mounting frame further comprises at least one coupler, each of said at least one coupler to couple one of the at least one coupling member to the pressing member.

14. The battery pack assembly of claim 11, wherein the at least one mounting aperture comprises three mounting apertures, and wherein the at least one coupling member comprises three coupling members, each of said coupling members extend through a corresponding one of the three mounting apertures respectively and are coupled to the support body.

15. The battery pack assembly of claim 10, wherein the plurality of cell spaces are arranged in at least one direction on a plane of the holder case, and each of said at least one mounting aperture being adjacent to cell spaces in the at least one direction.

16. The battery pack assembly of claim 10, wherein the plurality of cell spaces are arranged in a first direction and in a second direction that is different from the first direction on a plane of the holder case, and each of said at least one mounting aperture neighbors at least one first cell space in the first direction and at least one second cell space in the second direction.

17. The battery pack assembly of claim 16, wherein at least one first cell space is arranged at each of both sides of each of the at least one mounting apertures in the first direction.

18. The battery pack assembly of claim 16, wherein at least one second cell space is arranged at each of both sides of each of the at least one mounting apertures in the second direction.

19. The battery pack assembly of claim 10, wherein the plurality of cell spaces are arranged in column and row directions on a plane of the holder case, and each of said at least one mounting aperture is arranged between a first and a last column, excluding the first and the last column of a row in which the at least one mounting aperture is arranged.
